(19) United States
(12) Patent Application Publication
(10) Pub. No.: US 2005/0131124 A1
(43) Pub. Date: Jun. 16, 2005

(54) High temperature diesel-resistant polyacetal molded articles

(76) Inventors: Jean-Michel Philippoz, Prangins (CH); Philip L. Boydell, Challex (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/001,290

(22) Filed: Dec. 1, 2004

Related U.S. Application Data
(60) Provisional application No. 60/529,911, filed on Dec. 15, 2003.

(51) Int. Cl. C08K 3/18; C08K 3/10

(52) U.S. Cl. 524/436; 524/433

(57) ABSTRACT

Molded parts exhibiting enhanced resistance to high temperature diesel fuel and improved tensile modulus are provided. The molded parts are made from a composition comprising from 85 to 99.8% by weight of a polyoxymethylene copolymer, and from 0.2 to 15% by weight magnesium hydroxide. The molded parts may further include from 0.01 to 5% by weight of a component selected from the group of amidine compounds and metal oxides. The amidine compound may be cyanoguanidine and the metal oxide may be magnesium oxide. The molded part exhibit reduced weight loss when exposed to diesel fuel at a temperature of at least about 60° C. during use.

### CROSS REFERENCE TO RELATED APPLICATION

This application claims the benefit of U.S. provisional application No. 60/529,91 1, filed Dec. 15, 2003.

### BACKGROUND OF THE INVENTION

The present invention relates to high temperature diesel-resistant molded parts, and in particular, to high temperature diesel-resistant molded parts made from polyacetal copolymer compositions.

Polyacetal (or polyoxymethylene) resins exhibit excellent mechanical and physical properties, such as tensile strength, stiffness, as well as fatigue resistance, sliding resistance, chemical resistance, and the like. The resins are used extensively in various applications as an engineering plastic material due to their excellent physical properties (such as mechanical and electrical properties) and chemical resistance.

One application is in the automobile industry, where polyacetal resins are used to make various molded parts. In recent years, polyacetal has been used in fuel systems, in which certain parts may remain in contact with fuel inside the fuel tank of a motor vehicle. A new fuel system technology for diesel powered motor vehicles, known as the “common rail” fuel injection system, provides greater fuel economy than existing fuel injection systems, but also results in higher temperature fuel being returned to the fuel tank compared to standard fuel injection systems. Temperatures as high as 120° C. may be reached in the returning fuel, which in turn increases the temperature of the fuel in the fuel tank. Consequently, the temperature requirements for polymer resins used in fuel systems of diesel powered vehicles have been raised from about 60° C. to about 90° C.

It has been found that diesel fuel at elevated temperatures significantly degrades polyoxymethylene resins. The sulfur or sulfur-containing compounds present in diesel fuel are known to oxidize on contact with air so as to make acidic sulfur compounds which decompose polyoxymethylene. Substantial weight loss is observed when standard polyoxymethylene polymer samples are submerged in diesel fuel at 90° C.

A variety of additives have been used with polyoxymethylene polymers and copolymers to decrease degradation during service or to improve stability during processing.

European Patent No. 0 855 424 A1 discloses diesel-resistant molded-parts made from a composition of polyoxymethylene homopolymer or copolymer, sterically hindered amine compounds, and benzotriazole, benzoate, or benzophenone derivatives. U.S. Pat. No. 6,489,388 discloses diesel-resistant molded parts made from a composition of polyoxymethylene homopolymer or copolymer, a polyalkylene glycol, and zinc oxide. PCT Publication WO 03/027177 discloses chlorine resistant compositions of polyoxymethylene homopolymer or copolymer, an antioxidant, a thermal stabilizer, a metal hydroxide and a metal oxide. U.S. Pat. No. 4,788,258 discloses the addition of formaldehyde scavengers to oxymethylene copolymer, where the scavengers include amides, ureas, amines, and metal oxides and hydroxides.

As explained in greater detail below, it is believed that molded parts made from currently available diesel-resistant polyacetal compositions still exhibit undesirable levels of weight loss when exposed to diesel fuel at high temperatures over an extended period of time. Because weight loss is concomitant with loss of material and consequently reduction in mechanical integrity of the part, it is therefore desirable to provide a diesel-resistant molded part in which weight loss caused by exposure to diesel fuel at high temperatures over an extended period of time is confined to an acceptable level.

### SUMMARY OF THE INVENTION

A high temperature diesel-resistant molded part is made from a composition comprising from 85 to 99.8% by weight of a polyoxymethylene copolymer, and from 0.2 to 15% by weight magnesium hydroxide. Preferably, the composition of the molded part is further comprised of from 0.01 to 5% by weight of a component selected from the group of amidine compounds and metal oxides. According to a more preferred embodiment of the invention, the high temperature diesel-resistant molded part is comprised of from 92 to 99.4% by weight of a polyoxymethylene copolymer, from 0.5 to 5% by weight magnesium hydroxide, and from 0.1 to 3% by weight of a component selected from the group of amidine compounds and metal oxides.

According to a preferred embodiment of the invention, the amidine compound in the composition of the molded part is a cyano-guanidine compound or melamine. More preferably, the amidine compound is cyanoguanidine. According to another preferred embodiment of the invention, the metal oxide in the composition of the molded part is magnesium oxide.

DETAILED DESCRIPTION OF THE INVENTION

Molded parts according to this invention are resistant to diesel fuel, even at high temperatures of at least about 90° C. The molded parts are used in a variety of situations where they are exposed to diesel fuel. As used herein, the term “high temperature diesel-resistant molded part” refers to molded parts used in applications where the part comes into direct contact with heated diesel fuel, including but not limited to parts in a motor vehicle fuel system such as fuel tanks, fuel lines, other fuel conveying units, fuel level sensors, fuel module systems, flanges, splash pots, swirl pots, pump holders, fuel pumps, pump lids, filter sieves, negative-pressure valves, holders for diesel fuel pumps, pump housings, and internal parts for diesel fuel pumps. Of course, this invention is not limited to automotive applications and includes molded parts and their use in other applications where exposure to diesel fuel is encountered.

The molded parts may be produced by any molding process known to one of ordinary skill in the art, including without limitation compression molding, injection molding, blow molding, rotational molding, melt spinning, and thermoforming.

The present invention relates to a molding that contacts diesel fuel, wherein the molding comprises a mixture of:
(A) from 85 to 99.8% by weight of a polyoxymethylene copolymer; and
(B) from 0.2 to 15% by weight magnesium hydroxide.

According to the invention, the main component of the diesel resistant moldings of the invention is polyoxymethylene copolymer. Any polyoxymethylene copolymer may be used, but a typical copolymer is a high-molecular weight polymer comprising between about 85 to 99.9% of repeating oxymethylene units randomly interspersed with higher oxyalkylene units (e.g. having two or more adjacent carbon atoms). The oxymethylene units can be formed by a reaction of one or more monomers, such as those generally used in preparing polyacetal homopolymers, for example an anhydrous formaldehyde or a cyclic trimer thereof, such as trioxane. For the higher oxyalkylene units, the comonomers more commonly used include alkylene oxides of 2-12 carbon atoms and their cyclic addition products with formaldehyde. The quantity of comonomer will typically not be more than about 20 weight percent, preferably not more than about 15 weight percent, and most preferably not more than about 2 weight percent of the copolymer. A frequently preferred comonomer is ethylene oxide. A useful copolymer is prepared, for example, from about 98.6 wt % trioxane and about 1.4 wt % dioxolane, and has a melt flow rate of about 12 g/10 min when measured according to ISO 1133 (190° C., 2.16 kg).

The diesel resistant moldings of the invention comprise from 0.2 to 15% by weight magnesium hydroxide. More preferably between about 0.5 and 5.0% by weight of the composition is Mg(OH)₂, and most preferably between about 1.0 and 4.0% by weight of the composition is Mg(OH)₂. In the present invention the addition of magnesium hydroxide comprising 0.2%-15% by weight increases the tensile modulus of the polyacetal part. Preferred ranges of magnesium hydroxide for improved modulus are 1-15%, 2-15%, 2-12% and 10-15% by weight.

According to a preferred embodiment of the invention, the diesel resistant moldings of the invention may further comprise between 0.01 and about 5 weight percent of an amidine compound or a metal oxide. The amidine compound is preferably a cyano-guanidine compound or melamine. Cyano-guanidine compounds include cyanoguanidine, itself, and other compounds containing the divalent 1-cyano-3,3 guanidino radical: 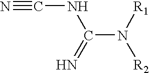
When cyanoguanidine is present in the composition, the cyanoguanidine is preferably between about 0.02 and about 2.0 weight percent of the composition, and more preferably between about 0.05 and about 1.0 weight percent of the composition, and most preferably between about 0.1 and about 0.5 weight percent of the composition based on the weight of the total composition. Cyanoguanidine is dicyandiamide, NH₂C(NH)(NHCN). Cyanoguanidine is available commercially from Degussa Fine Chemicals of Trostberg, Germany, under the trade name Dyhard. When a metal oxide is present in the composition, it preferably comprises between about 0.1 and 3.0 weight percent of the composition. The metal oxide is preferably selected from the group consisting of synthetic aluminum silicate, calcium oxide, magnesium oxide, aluminum oxide and magnesium aluminate. More preferably, the metal oxide is magnesium oxide and comprises between 0.1 and 2.0% by weight of the composition.

Optionally, the diesel resistant moldings may include conventional additives. The balance of the composition may include modifiers and other ingredients, including without limitation antioxidants, thermal stabilizers, UV stabilizers such as hindered amine light stabilizers, reinforcing agents, tougheners, lubricants, mold release agents, pigments and colorants. Preferably, such other additives comprise between 0 and 5% by weight of the composition and more preferably between 0 and 2.0% by weight of the composition based on the weight of the total composition.

The compositions described herein may be prepared by mixing the magnesium hydroxide, the amidine compound, and/or metal oxide components, and any additives employed, with the polyacetal copolymer at a temperature above the melting point of the polyacetal copolymer, by methods known in the art, such as by compounding in a twin-screw extruder.

The advantageous effects of this invention are demonstrated by a series of examples, as described below. The embodiments of the invention on which the examples are based are illustrative only, and do not limit the scope of the invention. The significance of the examples is better understood by comparing these embodiments of the invention with certain controlled formulations, which do not possess the distinguishing features of this invention.

### COMPARATIVE EXAMPLES

A polyoxymethylene copolymer was mixed in a twin-screw extruder with the various known stabilizers for polyoxymethylene set forth below at an extrusion temperature of about 220° C. In each case, the polyoxymethylene copolymer was an acetal copolymer prepared from about 98.8 weight percent trioxane and about 1.2 weight percent 1,3-dioxepane, and having a melt flow rate of about 13 g/10 min when measured according to ISO 1133 (190° C., 2.16kg).

EVOH: ethylene vinyl alcohol copolymer sold by Nippon Gohsei under the trade name Soarnol.

CNG: cyanoguanidine sold by Degussa Fine Chemicals under the trade name Dyhard G03

An extruded strand of each mixture was collected without granulation. A strand sample from each extruded mixture with a length of about 5 cm and a weight of about 1 gram was cut, weighed and placed in a test tube. Each sample was then submerged in the same commercial diesel fuel for 1080 hours, during which time the temperature of the diesel fuel was maintained at 90° C. The diesel fuel used was Haltermann CEC RF 90-A-92 diesel fuel (available from Haltermann, Hamburg, Germany). The samples were dried and weighed, and the percentage weight remaining for each of the samples was calculated and is reported in Table 1. The results of the test on the different compositions conducted with the same batch of diesel fuel can be compared against each other, but the results cannot be readily compared against other samples from other test series because the corrosiveness of different batches of diesel fuel varies due to variability in the sulfur content and in the exposure of the fuel to oxygen.

TABLE 1

| Comparative | | Wt. Percent | % of Sample |
|---|---|---|---|
| Example | Additive | Additive | Remaining |
| A | None | 0 | 7 |
| B | EVOH | 0.1 | 2 |
| C | EVOH | 0.3 | 5 |
| D | CNG | 0.2 | 66 |
| E | CNG | 0.5 | 100 |

It can be seen that the addition of the well-known polyacetal stabilizer EVOH provides the polyacetal copolymer resin copolymer with little or no resistance to diesel fuel. While the use of the stabilizer cyanoguanidine alone was found to improve diesel resistance, cyanoguanidine has been found to have the drawback that when added at high concentrations, cyanoguanidine may exude from polyacetal moldings.

### COMPARATIVE EXAMPLES F-P

A polyoxymethylene copolymer was mixed in a twin-screw extruder with the various known stabilizers for polyoxymethylene set forth below at an extrusion temperature of about 220° C. In each case, the polyoxymethylene copolymer was an acetal copolymer prepared from about 98.8 weight percent trioxane and about 1.2 weight percent 1,3-dioxepane, and having a melt flow rate of about 13 g/10 min when measured according to ISO 1133 (190° C., 2.16kg).

Tinuvin 622: oligomer of N-(2-hydroxyethyl)-2,2,6,6,-tetramethyl-4-piperidinol and succinic acid sold by Ciba Specialty Chemicals.

Irganox 245: ethylenebis (oxyethylene) bis[3-(5-tert-butyl4-hydroxy-m-tolyl) propionate] sold by Ciba Specialty Chemicals.

Irganox 1098: benzenepropanamide-N,N-1,6-hexanediylbis-[3,5-bis-(1,1-dimethylethyl)-4-hydroxy] sold by Ciba Specialty Chemicals.

Stabaxol P: polymeric carbodiimide with medium molecular weight sold by Rhein Chemie.

PEG 6000: polyethyleneglycol with a molecular weight of 6000 g/mol sold by Fluka.

An extruded stand of each mixture was collected without granulation. A strand sample from each extruded mixture with a length of about 5 cm and a weight of about 1 gram was cut, weighed and placed in a test tube. Each sample was then submerged for 624 hours in the same commercial diesel fuel as used in the above comparative examples, during which time the temperature of the diesel fuel was maintained at 90° C. The samples were dried and weighed, and the percentage weight remaining for each of the samples was calculated and is reported in Table 2.

TABLE 2

| Comparative | | Wt. Percent | % of Sample |
|---|---|---|---|
| Example | Additive | Additive | Remaining |
| F | None | 0 | 35 |
| G | Tinuvin 622 | 0.2 | 17 |
| H | Tinuvin 622 | 0.5 | 25 |
| I | Irganox 245 | 0.2 | 9 |
| J | Irganox 245 | 0.5 | 0 |
| K | Irganox 1098 | 0.2 | 30 |
| L | Irganox 1098 | 0.5 | 33 |
| M | Stabaxol P | 0.05 | 24 |
| N | Stabaxol P | 0.15 | 10 |
| O | PEG 6000 | 0.3 | 15 |
| P | PEG 6000 | 1.0 | 22 |

It can be seen that the addition of the well-know polyacetal stabilizers above provides the polyacetal copolymer resin with little or no resistance to diesel fuel.

### EXAMPLES 1-9 AND COMPARATIVE EXAMPLES Q-R

A polyoxymethylene copolymer was mixed in a twin-screw extruder alone or with various combinations of magnesium hydroxide, magnesium oxide, and cyanoguanidine at an extrusion temperature of about 220° C. In each case, the polyoxymethylene copolymer was an acetal copolymer prepared from about 98.6 weight percent trioxane and about 1.4 weight percent 1,3-dioxolane, and having a melt flow rate of about 12 g/10 min when measured according to ISO 1133 (190° C., 2.16kg). The extruded strand was granulated.

The granules were injection molded at a temperature of 21 0C. Tensile test bars with a thickness of 4 mm (ISO 527 Type 1A) were molded for testing of physical properties. The modulus data in Table 3 below reports the average from 10 samples, measured prior to exposure to diesel fuel. Modulus was measured and calculated according to ISO 527.

Additional granules of the same composition were injection molded at a temperature of 210° C. Mini-test bars, having a 1 mm thickness (same shape as ISO 527 Type 1A, except that all dimensions were divided by 4) were molded from the composition of each example and control. Three mini-test bars of each composition were placed on a rack and put in a 2 liter, PTFE-coated steel container such that the samples were not touching each other. The samples were then submerged for 312 hours in 1 liter of the same commercial diesel fuel as used in the comparative examples above, during which time the temperature of the diesel fuel was maintained at 100° C. and the lid was kept closed. The samples were dried and weighed after 168 hours in the fuel and were then placed back in the container with a fresh quantity of the same type diesel fuel. After the remaining 144 hours at 100°C., the samples were again dried and weighed, and the percentage weight remaining for each sample was calculated. The average weight remaining for each composition at 168 hours and 312 hours is reported in Table 3.

TABLE 3

| | Example | | | | |
|---|---|---|---|---|---|
| | Q | 1 | 2 | 3 | 4 |
| Acetal copolymer (wt %) | 100.0 | 99.0 | 97.4 | 98.0 | 96.4 |
| Mg(OH)₂ (wt %) | | 1.0 | 1.0 | 2.0 | 2.0 |
| Cyanoguanidine (wt %) | | | | | |
| MgO (wt %) | | | 1.6 | | 1.6 |
| Tensile modulus (GPa) | 2.79 | 2.96 | 2.94 | 3.01 | 2.97 |
| % Remaining @ 168 hrs | 29 | 51 | 66 | 56 | 65 |
| % Remaining @ 312 hrs | 0 | 0 | 37 | 24 | 39 |

| | Example | | | | | |
|---|---|---|---|---|---|---|
| | 5 | 6 | R | 7 | 8 | 9 |
| Acetal copolymer (wt %) | 96.2 | 96.8 | 99.8 | 95.2 | 95 | 88 |
| Mg(OH)₂ (wt %) | 3.0 | 3.0 | | 3.0 | 5 | 12 |
| Cyanoguanidine (wt %) | | 0.2 | 0.2 | 0.2 | | |
| MgO (wt %) | 0.8 | | | 1.6 | | |
| Tensile modulus (GPa) | 3.02 | 3.00 | 2.94 | 2.98 | 3.06 | 3.34 |
| % Remaining @ 168 hrs | 66 | 93 | 88 | 71 | 66 | 73 |
| % Remaining @ 312 hrs | 40 | 56 | 37 | 46 | 40 | 56 |

The examples in Table 3 show that the addition of magnesium hydroxide to the polyoxymethylene copolymer composition of the part improved the resistance of the molded part to hot diesel fuel. The examples further show that the compositions containing magnesium hydroxide and either cyanoguanidine or magnesium oxide had improved diesel resistance. These examples also show that the test bars molded from the various compositions of acetal copolymer and magnesium hydroxide exhibited increased modulus with increasing levels of magnesium hydroxide in the composition.

While this invention has been described with respect to what is at present considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent formulations and functions.

1. A high temperature diesel-resistant molded part made from a composition comprising from 85 to 99.8% by weight of a polyoxymethylene copolymer, and from 0.2 to 15% by weight magnesium hydroxide.

2. A high temperature diesel resistant molded part of claim 1 wherein the magnesium hydroxide improves the tensile modulus.

3. A high temperature diesel resistant molded part of claim 2, wherein the magnesium hydroxide range is 2-15% by weight.

4. A high temperature diesel resistant molded part of claim 2, wherein the magnesium hydroxide ranges from 10-15% by weight.

5. The high temperature diesel-resistant molded part of claim 1 further comprising from 0.01 to 5% by weight of a component selected from the group of amidine compounds and metal oxides

6. The high temperature diesel-resistant molded part of claim 5 wherein the composition is comprised of from 92 to 99.4% by weight of a polyoxymethylene copolymer, from 0.5 to 5% by weight magnesium hydroxide, and from 0.1 to 3% by weight of a component selected from the group of amidine compounds and metal oxides.

7. The high temperature diesel-resistant molded part of claim 5 wherein the amidine compound is a cyano-guanidine compound or melamine.

8. The high temperature diesel-resistant molded part of claim 5 wherein the amidine compound is cyanoguanidine.

9. The high temperature diesel-resistant molded part of claim 5 wherein the metal oxide is magnesium oxide.

10. The high temperature diesel-resistant molded part of claim 5 wherein the composition is comprised of from 94.5 to 99.4% by weight of a polyoxymethylene copolymer, from 0.5 to 5% by weight magnesium hydroxide, and from 0.1 to 0.5% by weight of cyanoguanidine.

11. The high temperature diesel-resistant molded part of claim 5 wherein the composition is comprised of from 92 to 99.4% by weight of a polyoxymethylene copolymer, from 0.5 to 5% by weight magnesium hydroxide, and from 0.1 to 3% by weight of magnesium oxide.

12. The high temperature diesel-resistant molded part of claim 1 wherein said molded part comprises an automotive diesel fuel system part.

13. A process for inhibiting the degradation of plastic moldings that contact high temperature diesel fuel, including the steps of:
molding a plastic part from a composition comprising from 85 to 99.8% by weight of a polyoxymethylene copolymer, and from 0.2 to 15% by weight magnesium hydroxide; and
contacting the molded plastic part with diesel fuel at a temperature of at least about 60° C.

14. The process of claim 13 wherein the composition from which the plastic part is molded further comprises from 0.01 to 5% by weight of a component selected from the group of amidine compounds and metal oxides.

15. Use of a diesel-resistant molding composition, comprising from 85 to 99.8% by weight of a polyoxymethylene copolymer, from 0.2 to 10% by weight magnesium hydroxide, and from 0.01 to 5% by weight of a component selected from the group of amidine compounds and metal oxides, in a molded article that contacts diesel fuel.

16. The use of the molding composition of claim 15 wherein the composition is comprised of from 92 to 99.4% by weight of a polyoxymethylene copolymer, from 0.5 to 5% by weight magnesium hydroxide, and from 0.1 to 3% by weight of a component selected from the group of amidine compounds and metal oxides.

17. The use of the molding composition of claim 15 wherein the amidine compound is a cyano-guanidine compound or melamine.

18. The use of the molding composition of claim 15 wherein the amidine compound is cyanoguanidine.

19. The use of the molding composition of claim 15 wherein the metal oxide is magnesium oxide.

20. The use of the molding composition of claim 15 in a motor vehicle fuel system molded part.

21. The use of the molding composition of claim 15 wherein the composition is comprised of from 94.5 to 99.4% by weight of a polyoxymethylene copolymer, from 0.5 to 5% by weight magnesium hydroxide, and from 0.1 to 0.5% by weight of cyanoguanidine.

22. The use of the molding composition of claim 15 wherein the composition is comprised of from 92 to 99.4% by weight of a polyoxymethylene copolymer, from 0.5 to 5% by weight magnesium hydroxide, and from 0.1 to 3% by weight of magnesium oxide.
